(19) United States
(12) Patent Application Publication
(10) Pub. No.: US 2022/0126608 A1
(43) Pub. Date: Apr. 28, 2022

(54) PRINTING APPARATUS, METHOD FOR ADJUSTING TENSION OF TRANSPORTING BELT IN PRINTING APPARATUS, AND PROGRAM FOR CONTROLLING ADJUSTMENT PATTERN PRINTING

(71) Applicant: SEIKO EPSON CORPORATION, Tokyo (JP)

(72) Inventor: Kenji Yamaguchi, Matsumoto-shi (JP)

(21) Appl. No.: 17/452,080

(22) Filed: Oct. 25, 2021

(30) Foreign Application Priority Data
Oct. 27, 2020 (JP) 2020-179327

(51) Int. Cl. B41J 11/42; B41J 11/00

(52) U.S. Cl. CPC B41J 11/42; B41J 11/007

(57) ABSTRACT

A printing apparatus includes a transport unit including a drive roller, a driven roller, and an endless transporting belt, and transporting a recording medium supported by the transporting belt in a transport direction by rotating the drive roller in the normal direction, a printing head configured to perform printing on the recording medium, and a control unit configured to cause the transport unit to rotate the transporting belt in a forward direction when causing the transport unit to transport the recording medium in the transport direction. The transport unit includes a brake unit configured to apply a brake on the driven roller. The control unit causes the transport unit to perform a tension adjustment process of adjusting tension of the transporting belt by rotating the drive roller in the normal direction in a state in which the driven roller is braked by the brake unit before the printing.

The present application is based on, and claims priority from JP Application Serial Number 2020-179327, filed Oct. 27, 2020, the disclosure of which is hereby incorporated by reference herein in its entirety.

### BACKGROUND

### 1. Technical Field

The present disclosure relates to a printing apparatus including an endless transporting belt that supports a recording medium, a method for adjusting the tension of the transporting belt in the printing apparatus, and a program for controlling of adjustment pattern printing.

### 2. Related Art

As a printing apparatus provided with an endless transporting belt that supports a recording medium, for example, a serial textile printer is known. The serial textile printer repeats a main scanning for ejecting ink droplets onto a recording medium from a printing head moving in a width direction that intersects a transport direction of a long recording medium, and a sub scanning for intermittently transporting the recording medium in the transport direction. In the textile printer, the recording medium is brought into contact with an upper part of the transporting belt that advances in the transport direction of the recording medium, and a cleaning unit is brought into contact with a lower part of the transporting belt that returns in a reverse direction to the transport direction by being raised. After printing is completed, the textile printer lowers the cleaning unit and slightly rotates the transporting belt in the reverse direction so that the water droplets attaching to the lower part of the transporting belt do not wet the recording medium in the next printing.

JP-A-11-316505 discloses a color image forming apparatus including a drive roller directly coupled to a first motor, a driven roller that is rotationally driven by a second motor so as to rotate in the reverse direction to the drive roller, and a transfer belt held by the drive roller and the driven roller. The drive roller has a higher coefficient of friction than the driven roller. During printing, both the drive roller and the driven roller are always rotationally driven. In this case, since a large tension is applied to the transporting belt between the drive roller and the driven roller as compared with a case in which the drive roller alone is rotationally driven, undulations of the transporting belt are corrected.

When the transporting belt rotates slightly in the reverse direction due to equipment maintenance or the like after the printing is completed, the looseness occurs at the contact surface of the transporting belt with the recording medium. When printing is started from this state, recording misalignment occurs in the printed image at the start of printing. In particular, when the printing apparatus is of the serial system, the recording misalignment at the start of printing is easily noticeable. The color image forming apparatus described above does not consider the recording misalignment occurring at the start of printing.

Note that the problem described above exists not only in serial textile printers, but also in various printing apparatuses such as line printing printers.

### SUMMARY

According to an aspect of the present disclosure, there is provided a printing apparatus including a transport unit including a drive roller configured to rotate in a normal direction and in a reverse direction, a driven roller, and an endless transporting belt stretched between the drive roller and the driven roller to support a recording medium, and transporting the recording medium supported by the transporting belt that is rotated by drive of the drive roller, in a transport direction by rotating the drive roller in the normal direction, a printing head configured to perform printing on the recording medium supported by the transporting belt, and a control unit configured to cause the transport unit to rotate the transporting belt in a forward direction in which the recording medium is transported in the transport direction by rotating the drive roller in the normal direction when causing the transport unit to transport the recording medium in the transport direction, in which the transport unit includes a brake unit configured to apply a brake on the driven roller, and the control unit causes the transport unit to perform a tension adjustment process of adjusting tension of the transporting belt by rotating the drive roller in the normal direction in a state in which the driven roller is braked by the brake unit before the printing.

According to another aspect of the present disclosure, there is provided a method for adjusting tension of a transporting belt in a printing apparatus, in which the printing apparatus includes a transport unit including a drive roller configured to rotate in a normal direction and in a reverse direction, a driven roller, and an endless transporting belt stretched between the drive roller and the driven roller to support a recording medium, and transporting the recording medium supported by the transporting belt that is rotated by drive of the drive roller, in a transport direction by rotating the drive roller in the normal direction, and a printing head configured to perform printing on the recording medium supported by the transporting belt, and the transport unit rotates the transporting belt in a forward direction in which the recording medium is transported in the transport direction by rotating the drive roller in the normal direction when transporting the recording medium in the transport direction, the method including adjusting the tension of the transporting belt by rotating the drive roller in the normal direction in a state in which the driven roller is braked before the printing.

According to still another aspect of the present disclosure, there is provided a non-transitory computer-readable storage medium storing a program for controlling adjustment pattern printing for a printing apparatus, in which the printing apparatus includes a transport unit including a drive roller configured to rotate in a normal direction and in a reverse direction, a driven roller, and an endless transporting belt stretched between the drive roller and the driven roller to support a recording medium, and transporting the recording medium supported by the transporting belt that is rotated by drive of the drive roller, in a transport direction by rotating the drive roller in the normal direction, and a printing head including a plurality of nozzles arranged in an arrangement direction intersecting a width direction of the transporting belt and configured to perform printing on the recording medium supported by the transporting belt, the transport unit rotates the transporting belt in a forward direction in which the recording medium is transported in the transport direction by rotating the drive roller in the normal direction when transporting the recording medium in the transport direction, the plurality of nozzles include a first nozzle row and a second nozzle row that is offset from the first nozzle row in the transport direction by a predetermined distance, and the transport unit includes a brake unit configured to apply a brake on the driven roller, the program causing a computer to implement a back-feeding function configured to perform a first process of rotating the transporting belt in a reverse direction by a predetermined amount by causing the transport unit to rotate the drive roller in the reverse direction, a tension adjustment function configured to perform a second process of causing the transport unit to rotate the drive roller in the normal direction by a set amount in a state in which the driven roller is braked by the brake unit after the first process, a first print control function configured to perform a third process of printing a first adjustment pattern on the recording medium by causing the printing head to eject an ink droplet from the first nozzle row after the second process, a transport control function configured to perform a fourth process of transporting the recording medium in the transport direction by the predetermined distance by causing the transport unit to rotate the drive roller in the normal direction after the third process, and a second printing control function configured to perform a fifth process of printing a second adjustment pattern on the recording medium by causing the printing head to eject an ink droplet from the second nozzle row after the fourth process.

### BRIEF DESCRIPTION OF THE DRAWINGS

FIG. 1 is a front view schematically illustrating an example of a printing apparatus including an endless transporting belt that supports a recording medium.

FIG. 2 is a plan view schematically illustrating the example of the printing apparatus.

FIG. 3 is a bottom view schematically illustrating an example of a nozzle surface of a printing head.

FIG. 4 is a block diagram schematically illustrating a configuration example of an electrical circuit of the printing apparatus.

FIG. 5 is a diagram schematically illustrating an operation example of a transport unit and a cleaning unit.

FIG. 6 is a flowchart schematically illustrating an example of a printing process performed in the printing apparatus.

FIG. 7 is a flowchart schematically illustrating an example of an adjustment pattern printing process performed in the printing apparatus.

FIG. 8 is a diagram schematically illustrating an example in which the printing apparatus prints an adjustment pattern.

FIG. 9 is a diagram schematically illustrating examples of a plurality of adjustment patterns printed with different normal rotation amounts.

FIG. 10 is a flowchart schematically illustrating an example of an adjustment process performed in the printing apparatus.

### DESCRIPTION OF EXEMPLARY EMBODIMENTS

Hereinafter, exemplary embodiments of the present disclosure will be described. Of course, the following exemplary embodiments only illustrate the present disclosure, and not all features illustrated in the exemplary embodiments are indispensable for the solution of the disclosure.

### 1. OVERVIEW OF TECHNIQUE INCLUDED IN PRESENT DISCLOSURE

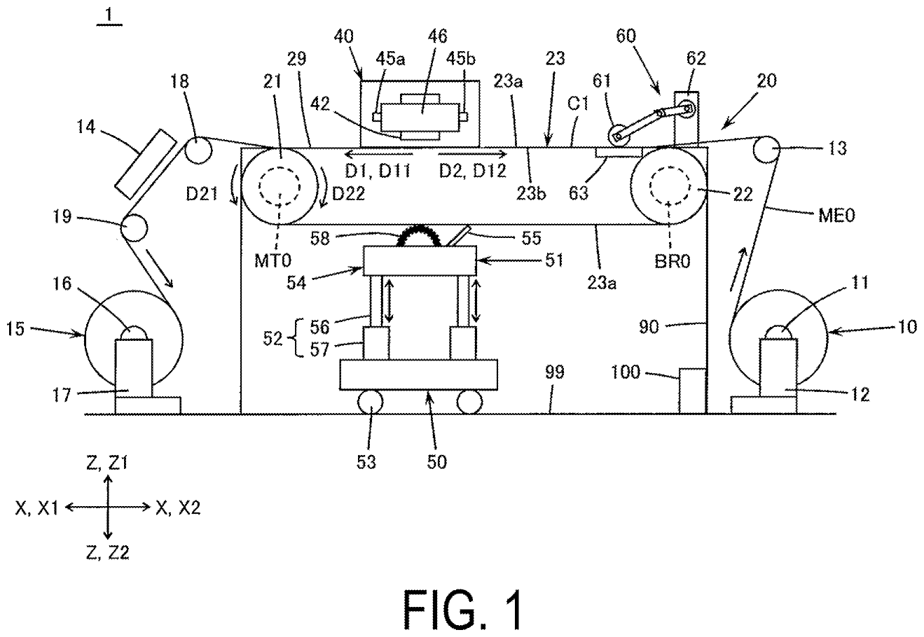

First, an overview of the technique included in the present disclosure will be described with reference to examples illustrated in FIGS. 1 to 10. Note that the drawings of the present application schematically illustrate the examples, the scale of each member may differ from the actual scale in order to make each member of these drawings recognizable, magnification in each direction illustrated in these drawings may vary, and the drawings may not be consistent with one another. Of course, the elements of the technique are not limited to specific examples illustrated with reference numerals. In the “Overview of Technique Included in Present Disclosure”, the description in parentheses means supplementary explanation of the preceding word.

Aspect 1

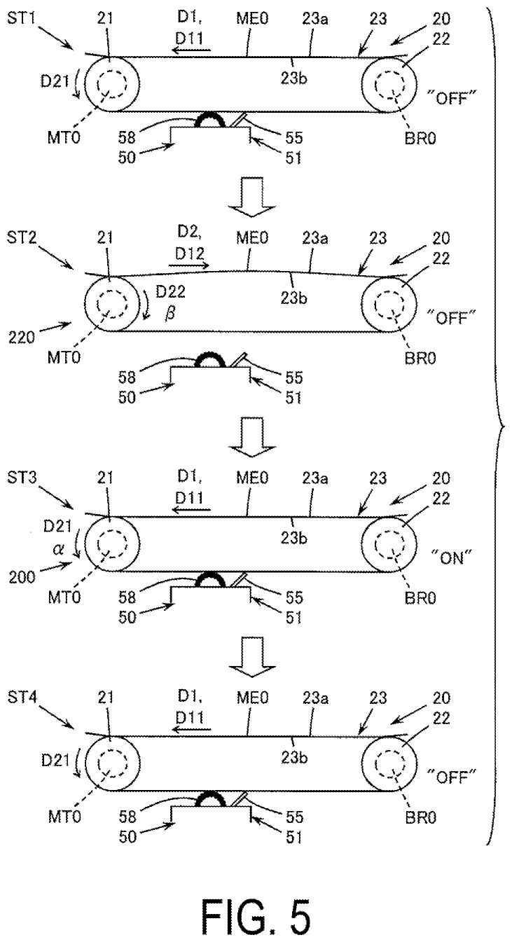

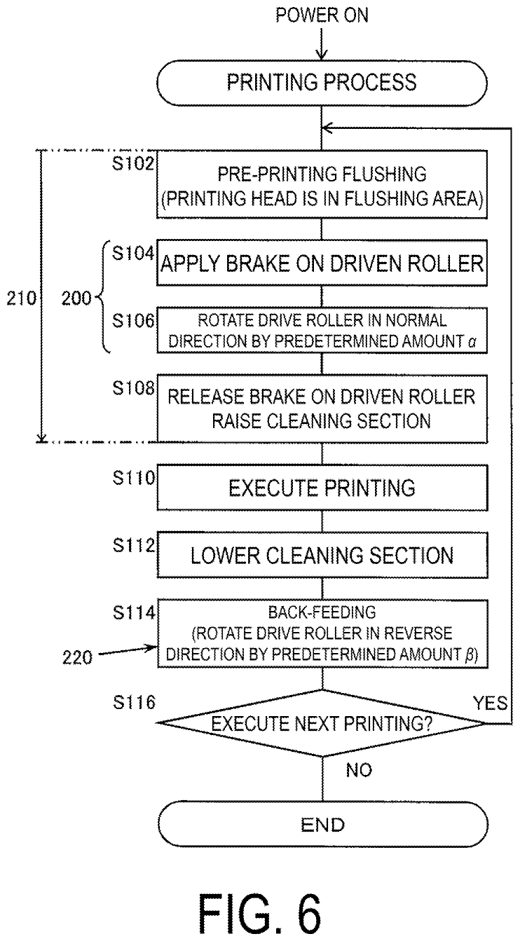

A printing apparatus 1 according to an aspect of the present technique includes a transport unit 20, a printing head 42, and a control unit 100. The transport unit 20 includes a drive roller 21 configured to rotate in a normal direction and in a reverse direction, a driven roller 22, and an endless transporting belt 23 stretched between the drive roller 21 and the driven roller 22 to support a recording medium ME0, and transports the recording medium ME0 supported by the transporting belt 23, which is rotated by drive of the drive roller 21, in a transport direction D1 by rotating the drive roller 21 in the normal direction. The printing head 42 prints on the recording medium ME0 supported by the transporting belt 23. When the control unit 100 causes the transport unit 20 to transport the recording medium ME0 in the transport direction D1, the transport unit 20 rotates the transporting belt 23 in a forward direction D11 in which the recording medium ME0 is transported in the transport direction D1 by rotating the drive roller 21 in the normal direction. The transport unit 20 includes a brake unit BRO configured to apply a brake on the driven roller 22. As illustrated in FIGS. 5 and 6, the control unit 100 causes the transport unit 20 to perform a tension adjustment process 200 that adjusts tension of the transporting belt 23 by rotating the drive roller 21 in the normal direction in a state in which the driven roller 22 is braked by the brake unit BRO before the printing.

Since the drive roller 21 rotates in the normal direction in the state in which the driven roller 22 is braked before printing, the tension of the transporting belt 23 is adjusted even when a support portion of the transporting belt 23 for supporting the recording medium ME0 (for example, a surface 23a on an upper side of the transporting belt 23) is loose. Accordingly, in the above-described aspect, it is possible to provide a printing apparatus that suppresses recording misalignment that occurs at the start of printing.

Examples of the recording medium include a textile and a film. The recording medium may be supported by the transporting belt, and is not limited to a long shape such as a roll shape, but may be a cut shape.

Note that the above-described additional notes are also applied in the following aspects.

Aspect 2

As illustrated in FIGS. 5 and 6, the control unit 100 may cause the transport unit 20 to perform a back-feeding process 220 of rotating the transporting belt 23 in a reverse direction D12 by rotating the drive roller 21 in a reverse direction. Further, the control unit 100 may cause the transport unit 20 to perform the tension adjustment process 200 after the back-feeding process 220 and before the printing. Furthermore, the control unit 100 may cause the transport unit 20 to release the brake on the driven roller 22 by the brake unit BRO before the printing.

When the back-feeding process 220 is performed, the support portion (23a) of the transporting belt 23 for supporting the recording medium ME0 is loosened. After the back-feeding process 220 and before printing, the drive roller 21 rotates in the normal direction in the state in which the driven roller 22 is braked, so that the tension of the transporting belt 23 is adjusted. Accordingly, in the above-described aspect, it is possible to suppress recording misalignment due to looseness of the support portion of the transporting belt for supporting the recording medium due to the back-feeding.

Aspect 3

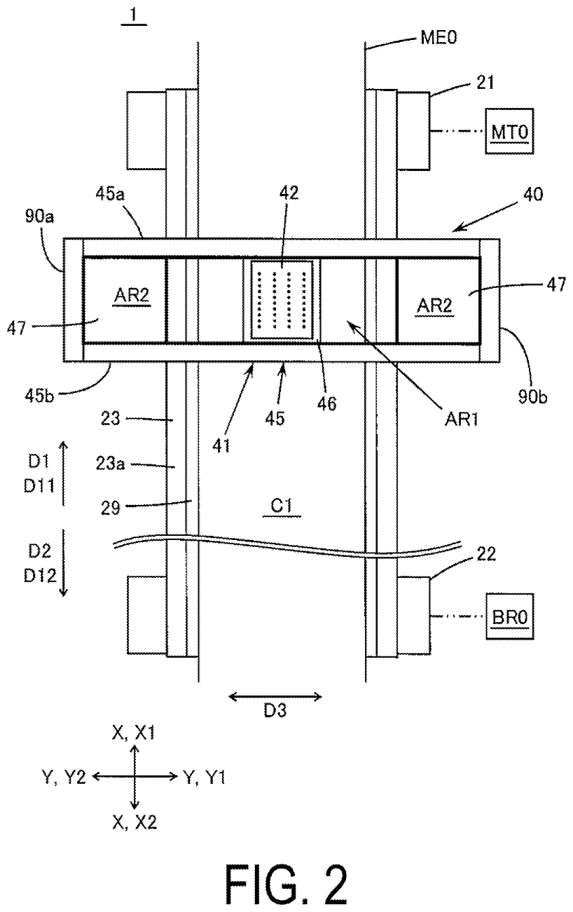

As illustrated in FIG. 2, the printing apparatus 1 may further include a head transfer unit 45 configured to move the printing head 42 to a print execution area AR1 facing the transporting belt 23 and a flushing area AR2 not facing the transporting belt 23. The control unit 100 may cause the transport unit 20 to perform the tension adjustment process 200 during a print preparation period 210 including a period in which the printing head 42 is located in the flushing area AR2. In the present aspect, since the tension adjustment process 200 is performed during the print preparation period 210 including the period in which the printing head 42 is located in the flushing area AR2, it is possible to provide a suitable example of performing the tension adjustment process.

Aspect 4

The control unit 100 may control acceleration of the normal rotation of the drive roller 21 when the tension adjustment process 200 is performed so as to be equal to acceleration of the normal rotation of the drive roller 21 when the printing is performed. In this aspect, since the support portion of the transporting belt 23 for supporting the recording medium ME0 has an appropriate tension at the start of printing, a suitable example of performing tension adjustment process can be provided.

Aspect 5

As illustrated in FIG. 6, the control unit 100 may cause the transport unit 20 to perform the tension adjustment process 200 when the printing apparatus 1 is powered on. When the printing apparatus 1 is powered on, there is a possibility that the support portion (23a) of the transporting belt 23 for supporting the recording medium ME0 is loose. In the present aspect, when the printing apparatus 1 is powered on, the drive roller 21 rotates in the normal direction in the state in which the driven roller 22 is braked, so that the tension of the transporting belt 23 is adjusted. Accordingly, in the present aspect, even when the support portion of the transporting belt for supporting the recording medium is loose when the printing apparatus is powered on, recording misalignment can be suppressed.

Aspect 6

Further, in a method for adjusting the tension of the transporting belt 23 in the printing apparatus 1 according to an aspect of the present technique, the printing apparatus 1 includes the transport unit 20 and the printing head 42. When the transport unit 20 transports the recording medium ME0 in the transport direction D1, the transport unit 20 rotates the transporting belt 23 in the forward direction D11 in which the recording medium ME0 is transported in the transport direction D1 by rotating the drive roller 21 in the normal direction. As illustrated in FIGS. 5 and 6, in the method for adjusting tension, the tension of the transporting belt 23 is adjusted by rotating the drive roller 21 in the normal direction in the state in which the driven roller 22 is braked before the printing.

Since the drive roller 21 rotates in the normal direction in the state in which the driven roller 22 is braked before printing, the tension of the transporting belt 23 is adjusted even when the support portion (23a) of the transporting belt 23 for supporting the recording medium ME0 is loose. Accordingly, in the above-described aspect, it is possible to provide a method for adjusting tension that can suppress recording misalignment that occurs at the start of printing.

Aspect 7

Further, in a program PR2 for controlling adjustment pattern printing for the printing apparatus 1 according to an aspect of the present technique, the printing apparatus 1 includes the transport unit 20 and the printing head 42. When the transport unit 20 transports the recording medium ME0 in the transport direction D1, the transport unit 20 rotates the transporting belt 23 in the forward direction D11 in which the recording medium ME0 is transported in the transport direction D1 by rotating the drive roller 21 in the normal direction. Plurality of nozzles 43 include a first nozzle row NA1 and a second nozzle row NA2 that is offset from the first nozzle row NA1 in the transport direction D1 by a predetermined distance L1. The transport unit 20 includes the brake unit BRO configured to apply a brake on the driven roller 22.

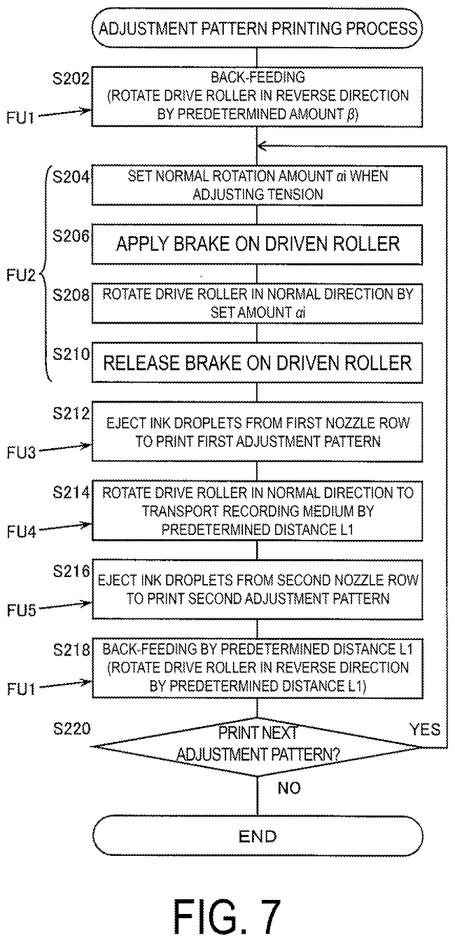

As illustrated in FIG. 7, the program PR2 for controlling adjustment pattern printing causes a computer (for example, the printing apparatus 1) to implement a back-feeding function HA, a tension adjustment function FU2, a first print control function FU3, a transport control function FU4, and a second print control function FU5. The back-feeding function HA performs a first process of rotating the transporting belt 23 in the reverse direction D12 by a predetermined amount by causing the transport unit 20 to rotate the drive roller 21 in the reverse direction. After the first process, the tension adjustment function FU2 performs a second process of causing the transport unit 20 to rotate the drive roller 21 by a set amount αi in the normal direction in the state in which the driven roller 22 is braked by the brake unit BRO. After the second process, the first print control function FU3 performs a third process of printing a first adjustment pattern PA1 on the recording medium ME0 by causing the printing head 42 to eject an ink droplet 48 from the first nozzle row NA1. After the third process, the transport control function FU4 performs a fourth process of transporting the recording medium ME0 in the transport direction D1 by the predetermined distance L1 by causing the transport unit 20 to rotate the drive roller 21 in the normal direction. After the fourth process, the second print control function FU5 performs a fifth process of printing a second adjustment pattern PA2 on the recording medium ME0 by causing the printing head 42 to eject an ink droplet 48 from the second nozzle row NA2.

Since the drive roller 21 rotates in the normal direction by the set amount αi in the state in which the driven roller 22 is braked before printing the adjustment pattern, the tension of the transporting belt 23 is adjusted even when the support portion (23a) of the transporting belt 23 for supporting the recording medium ME0 is loose. In this state, the ink droplet 48 is ejected from the first nozzle row NA1 to print the first adjustment pattern PA1 on the recording medium ME0. After printing the first adjustment pattern PA1, the recording medium ME0 is transported in the transport direction D1 by the predetermined distance L1 and the ink droplet 48 is ejected from the second nozzle row NA2 offset from the first nozzle row NA1 in the transport direction D1 by the predetermined distance L1 to print the second adjustment pattern PA2 on the recording medium ME0. When there is recording misalignment at the start of printing, a misalignment occurs between the first adjustment pattern PA1 and the second adjustment pattern PA2. Accordingly, in the present aspect, the recording misalignment that occurs at the start of the adjustment pattern printing can be suppressed, and the extent of the recording misalignment can be confirmed.

Note that the present technique can be applied to a printing method corresponding to the printing apparatus described above, a printing apparatus and a printing method corresponding to the above-described program for controlling adjustment pattern printing, and the like.

### 2. SPECIFIC EXAMPLE OF PRINTING APPARATUS INCLUDING ENDLESS TRANSPORTING BELT THAT SUPPORTS RECORDING MEDIUM

FIG. 1 schematically illustrates the printing apparatus 1 including the endless transporting belt 23 that supports the recording medium ME0. FIG. 2 schematically illustrates the printing apparatus 1 viewed from above. In FIGS. 1 and 2, an X1 direction indicates the left direction, an X2 direction indicates the right direction opposite to the X1 direction, a Y1 direction indicates a rearward direction orthogonal to the X1 and X2 directions, a Y2 direction indicates a front direction opposite to the Y1 direction, a Z1 direction indicates an upward direction orthogonal to the X1 and X2 directions and the Y1 and Y2 directions, and a Z2 direction indicates a downward direction opposite to the Z1 direction. Here, the X1 and X2 directions are collectively referred to as an X direction, the Y1 and Y2 directions are collectively referred to as a Y direction, and the Z1 and Z2 directions are collectively referred to as a Z direction.

The printing apparatus 1 illustrated in FIGS. 1 and 2 is a serial ink jet printer, and is a textile printer that prints on a textile as the recording medium ME0 by ejecting ink droplets from the printing head 42. The printing apparatus 1 includes the transport unit 20, a medium fitting unit 60, a printing unit 40, a drying unit 14, a cleaning unit 50, the control unit 100 that control these units, and the like. These units of the printing apparatus 1 are attached to a frame section 90.

The transport unit 20 includes a medium supply unit 10, the drive roller 21, a servo motor MT0, the driven roller 22, the brake unit BRO, the endless transporting belt 23, a medium collecting unit 15, and the like. The recording medium ME0 is transported along a transport path Cl from the medium supply unit 10 to the medium collecting unit 15. The transport direction D1 of the recording medium ME0 on the transporting belt 23 is the X1 direction, and the back-feeding direction D2 opposite to the transport direction D1 is the X2 direction.

The medium supply unit 10 includes a cylindrical or columnar feeding shaft section 11, a bearing section 12, and a rotation drive unit (not illustrated) for rotationally driving the supply shaft section 11, and feeds out the roll-shaped recording medium ME0. As a material of the textile as the recording medium ME0, chemical fibers such as cotton, silk, wool, or polyester fibers, blended fibers, or the like can be used. The feeding shaft section 11 is detachably attached to the bearing section 12 and is rotatable in the circumference direction. The strip-shaped recording medium ME0 wound beforehand around the feeding shaft section 11 can be attached to the bearing section 12 together with the feeding shaft section 11. The bearing section 12 rotatably supports both ends of the feeding shaft section 11 in an axis direction. The rotation drive unit rotates the feeding shaft section 11 in a direction in which the recording medium ME0 is fed out according to the control by the control unit 100. The recording medium ME0 unwound from the medium supply unit 10 is changed in direction by a transport roller 13 and is fed onto the transporting belt 23.

The transporting belt 23 has an endless shape in which both end portions of the strip-shaped belt are coupled. The transporting belt 23 is stretched between the drive roller 21 and the driven roller 22, and supports the recording medium ME0 on the surface 23a on the upper side thereof that advances in the transport direction D1. When the upper part of the transporting belt 23 advances in the X1 direction, which is the transport direction D1, the lower part of the transporting belt 23 advances in the X2 direction. The transporting belt 23 is retained in a state in which a predefined tension is applied so that the part between the driven roller 22 and the drive roller 21 is flat. The transport unit 20 may further include a support unit such as a roller that supports the transporting belt 23 including a tension roller that adjusts the tension of the transporting belt 23 other than the rollers 21 and 22. An adhesive layer 29 for adhering the recording medium ME0 is provided on the surface 23a of the transporting belt 23. The surface 23a on the upper side of the transporting belt 23 functions as a support surface for supporting the recording medium ME0 which is close contact with the adhesive layer 29 by the medium fitting unit 60 described later. As a result, the ink droplets can be accurately landed on the recording medium ME0 such as an elastic textile.

Note that the transporting belt is not limited to the transporting belt provided with the adhesive layer, and may be an electrostatic attraction transporting belt or the like to which a recording medium is attracted by static electricity.

The drive roller 21 is disposed downstream of the printing unit 40 including the printing head 42 with the center line of the rotation directed in the Y direction, which is a width direction D3 of the transporting belt 23. Here, the width direction D3 is also the width direction of the transport path Cl. Being disposed downstream means that the drive roller 21 is disposed in the transport direction D1 from the printing unit 40 in plan view. An outer peripheral surface of the drive roller 21 is in contact with an inner peripheral surface 23b of the transporting belt 23. Since there is friction between the outer peripheral surface of the drive roller 21 and the inner peripheral surface 23b of the transporting belt 23, the drive roller 21 rotates the transporting belt 23 by rotating according to torque from the servo motor MT0. The drive roller 21 is capable of rotating in the normal direction and in the reverse direction. The drive roller 21 rotates the transporting belt 23 in the forward direction D11 by rotating in the normal direction according to the torque from the servo motor MT0 in the normal rotation direction D21, and rotates the transporting belt 23 in the reverse direction D12 by rotating in the reverse direction according to the torque from the servo motor MT0 in the reverse rotation direction D22.

The driven roller 22 is disposed upstream of the printing unit 40 including the printing head 42 with the center line of rotation directed in the Y direction. Here, being disposed upstream means that the driven roller 22 is disposed on the side opposite to the transport direction D1 with respect to the printing unit 40. An outer peripheral surface of the driven roller 22 is in contact with the inner peripheral surface 23b of the transporting belt 23. Since there is friction between the outer peripheral surface of the driven roller 22 and the inner peripheral surface 23b of the transporting belt 23, the driven roller 22 rotates as the transporting belt 23 rotates. The driven roller 22 rotates in the normal direction, which is the same direction as the normal rotation direction D21 of the drive roller 21, by the transporting belt 23 rotating in the forward direction D11, and rotates in the reverse direction, which is the same direction as the reverse rotation direction D22 of the drive roller 21, by the transporting belt 23 rotating in the reverse direction D12. Accordingly, when the transporting belt 23 rotates in the forward direction D11 by the normal rotation of the drive roller 21, the driven roller 22 rotates in the normal direction, and when the transporting belt 23 rotates in the reverse direction D12 by the reverse rotation of the drive roller 21, the driven roller 22 rotates in the reverse direction. The recording medium ME0 supported by the transporting belt 23 that is rotated by the drive of the drive roller 21 is transported in the transport direction D1 by the normal rotation of the drive roller 21. Printing is performed on the recording medium ME0 by the printing head 42 ejecting ink droplets on the recording medium ME0 supported by the transporting belt 23 between the driven roller 22 and the drive roller 21.

The driven roller 22 can be braked by the brake unit BRO. When the brake unit BRO brakes the driven roller 22 while the driven roller 22 is not rotating, the driven roller 22 does not rotate even when the transporting belt 23 attempts to rotate. The transport unit 20 transports the recording medium ME0 supported by the rotating transporting belt 23, which is rotated by the drive of the drive roller 21, by the normal rotation of the drive roller 21 in the transport direction D1 in the state in which the driven roller 22 is not braked.

The printed recording medium ME0 is sent out from the transporting belt 23, is changed direction by transport rollers 18 and 19, and is wound up by the medium collecting unit 15. The transport roller 18 has a function of peeling the recording medium ME0 on which a printed image is formed from the adhesive layer 29 of the transporting belt 23.

The printing apparatus 1 includes the drying unit 14 between the transport roller 18 and the transport roller 19. The drying unit 14 dries the ink adhering to the recording medium ME0. An infrared heater or the like can be used for the drying unit 14.

The medium collecting unit 15 includes a cylindrical or columnar winding shaft section 16, a bearing section 17, and a rotation drive unit (not illustrated) for rotationally driving the winding shaft section 16, and collects the printed recording medium ME0 by winding the printed recording medium ME0 in a roll shape. The winding shaft section 16 is detachably attached to the bearing section 17 and is rotatable in the circumference direction. The strip-shaped recording medium ME0 wound around the winding shaft section 16 is removable together with the winding shaft section 16. The bearing section 17 rotatably supports both ends of the winding shaft section 16 in an axial direction. The rotation drive unit rotates the winding shaft section 16 in a direction in which the recording medium ME0 is wound according to the control by the control unit 100.

The medium fitting unit 60 disposed upstream of the printing unit 40 includes a cylindrical or columnar press roller 61, a press roller drive unit 62, and a roller support section 63, and brings the recording medium ME0 into close contact with the surface 23a on the upper side of the transporting belt 23. The press roller 61 is rotatable in the circumferential direction about an axis oriented in the Y direction, and presses the recording medium ME0 against the surface 23a of the transporting belt 23. The roller support section 63 is in contact with the inner peripheral surface 23b of the transporting belt 23 so as to sandwich the transporting belt 23 between the roller support section 63 and the press roller 61. The press roller drive unit 62 moves the press roller 61 in the X1 direction and the X2 direction while pressing the press roller 61 in the Z2 direction. The recording medium ME0 superimposed on the transporting belt 23 is sandwiched between the press roller 61 and the roller support section 63, so that the recording medium ME0 is brought into close contact with the adhesive layer 29 of the transporting belt 23.

The printing unit 40 is disposed in the Z1 direction from the transporting belt 23, and prints on the recording medium ME0 placed on the surface 23a of the transporting belt 23. The printing unit 40 includes a head unit 41 including the printing head 42 that ejects ink droplets of a plurality of colors, a carriage 46 on which the head unit 41 is mounted, a head transfer unit 45 that moves the carriage 46 in the Y direction, which is the width direction D3 of the transporting belt 23, and the like. The head transfer unit 45 includes guide rails 45a and 45b whose longitudinal direction is directed to the Y direction, a transfer mechanism (not illustrated), and a power source (not illustrated). The guide rails 45a and 45b are bridged between frame sections 90a and 90b that are vertically placed on the outer sides of the transporting belt 23 in the width direction D3. The carriage 46 on which the head unit 41 is mounted is supported by the guide rails 45a and 45b so as to be movable in the Y1 direction and the Y2 direction between the guide rails 45a and 45b. The Y direction is a main scanning direction in which the printing head 42 is reciprocated in the serial printing apparatus 1. As the transfer mechanism, a mechanism combining a ball screw and a ball nut, a linear guide mechanism, or the like can be used. Examples of the motor used as the power source include various motors such as a stepping motor, a servo motor, and a linear motor. The power source and the transfer mechanism move the carriage 46 in the Y direction in accordance with the control by the control unit 100.

The head transfer unit 45 moves the printing head 42 to the print execution area AR1 facing the transporting belt 23 and the two flushing areas AR2 not facing the transporting belt 23. Each of the flushing areas AR2 is outside the print execution area AR1 in the width direction D3. In each of the flushing areas AR2, an ink receiver 47 is provided that receives ink droplets ejected from the printing head 42 at a position facing the printing head 42.

The cleaning unit 50 is disposed below the transporting belt 23 to clean the surface 23a on a lower side of the transporting belt 23 that returns in the direction opposite to the transport direction D1. The cleaning unit 50 includes a cleaning section 51, a pressing section 52, and a caster section 53. The caster section 53 can integrally move the cleaning unit 50 along a floor surface 99 and fix the cleaning unit 50 at a predetermined position. The pressing section 52 is an elevating device that raises and lowers the cleaning section 51, and includes, for example, air cylinders 56 and ball bushings 57.

The cleaning section 51 includes a cleaning tank 54, a brush roller 58, and a blade 55. The cleaning tank 54 stores a cleaning liquid used for cleaning ink and foreign materials adhering onto the surface 23a of the transporting belt 23. As the cleaning liquid, water, a water-soluble solvent such as an alcoholic aqueous solution, or the like may be used, and a surfactant agent or an anti-foaming agent may be added as necessary. The brush roller 58 is disposed inside the cleaning tank 54 and can rotate in a state of being in contact with the surface 23a on the lower side of the transporting belt 23. When the brush roller 58 rotates, the cleaning liquid is supplied to the surface 23a of the transporting belt 23, and the brush roller 58 rubs the surface 23a of the transporting belt 23. Consequently, the ink adhering to the surface 23a of the transporting belt 23, the fibers of the textile as the recording medium ME0, and the like are removed from the surface 23a. The blade 55 is disposed inside the cleaning tank 54 in the X2 direction from the brush roller 58 to remove the cleaning liquid from the surface 23a of the transporting belt 23 that rotates in the forward direction D11.

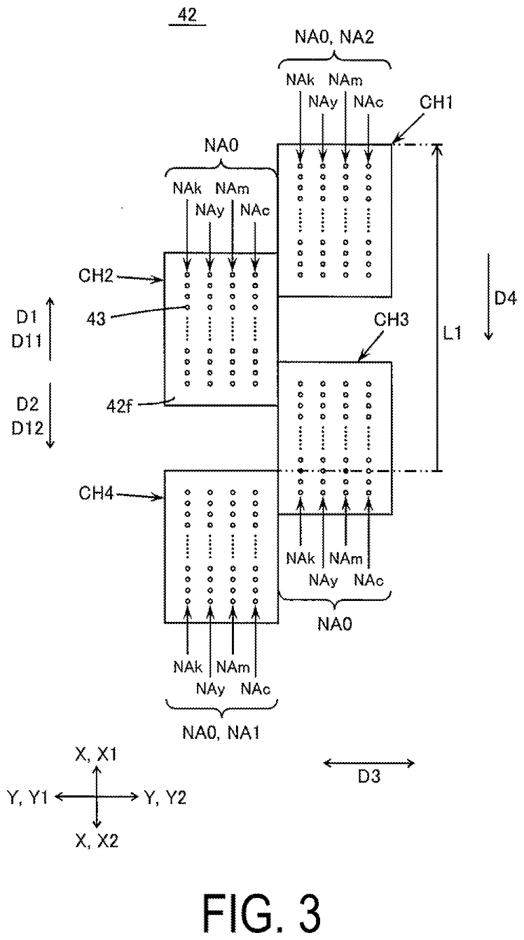

FIG. 3 schematically illustrates a nozzle surface 42f of the printing head 42. The nozzle surface 42f is a surface of the printing head 42 facing the transporting belt 23 or the ink receiver 47. The printing head 42 illustrated in FIG. 3 is divided into a first chip CH1, a second chip CH2, a third chip CH3, and a fourth chip CH4. Each of the chips CH1 to CH4 includes a plurality of nozzle rows NA0 arranged in the width direction D3 of the transporting belt 23. The plurality of nozzle rows NA0 illustrated in FIG. 3 include a cyan nozzle row NAc for ejecting cyan ink droplets, a magenta nozzle row NAm for ejecting magenta ink droplets, a yellow nozzle row NAy for ejecting yellow ink droplets, and a black nozzle row NAk ejecting black ink droplets. Each of the nozzle rows NA0 includes a plurality of nozzles 43 arranged in an arrangement direction D4 intersecting the width direction D3. Each of the nozzles 43 ejects ink droplets. The arrangement direction D4 of the plurality of nozzles 43 included in the nozzle rows NA0 illustrated in FIG. 3 is orthogonal to the width direction D3, but the arrangement direction D4 may intersect the width direction D3 obliquely without being orthogonal to the width direction D3. In addition, although the plurality of nozzles 43 included in each of the nozzle rows NA0 illustrated in FIG. 3 are arranged in a row, the plurality of nozzles included in the nozzle row may be arranged in a zigzag pattern.

In the printing head 42 illustrated in FIG. 3, the chips CH1 to CH4 are disposed in a zigzag pattern so that the adjacent chips overlap each other by one row of nozzles in the transport direction D1. In other words, the nozzles 43 at the end portion of the first chip CH1 on the X2 direction side and the nozzles 43 at the end portion of the second chip CH2 on the X1 direction side are at the same position in the transport direction D1, the nozzles 43 at the end portion of the second chip CH2 on the X2 direction side and the nozzles 43 at the end portion of the third chip CH3 on the X1 direction side are at the same position in the transport direction D1, and the nozzles 43 at the end portion of the third chip CH3 on the X2 direction side and the nozzles 43 at the end portion of the fourth chip CH4 on the X1 direction side are at the same position in the transport direction D1. The printing head 42 ejects ink droplets in a range from the nozzles 43 at the end portion of the chip CH1 on the X1 direction side to the nozzles 43 at the end portion of the chip CH4 on the X2 direction side when scanning in the width direction D3 to perform printing on the recording medium ME0 supported by the transporting belt 23. Of course, the overlap of the nozzles 43 between the chips in the transport direction D1 is not limited to one row of nozzles, and may be two or more rows of nozzles or may not be required.

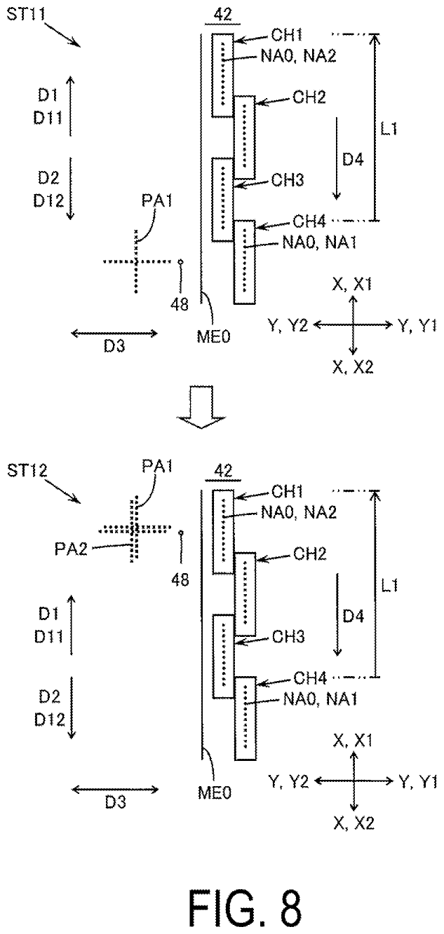

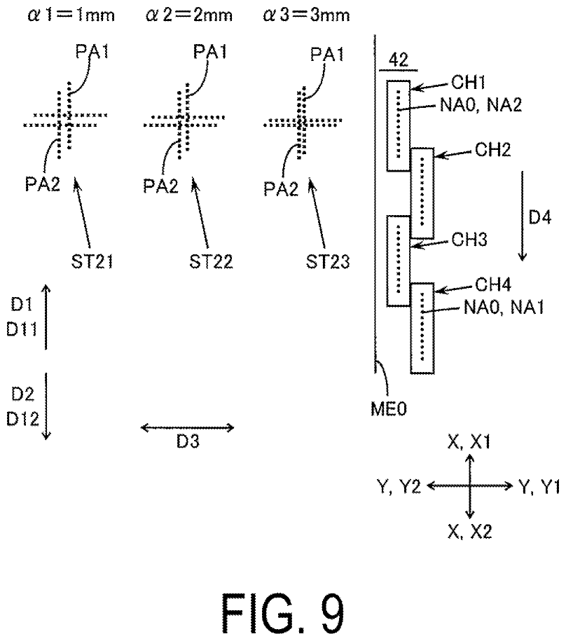

Note that for convenience in describing the adjustment patterns PA1 and PA2 illustrated in FIGS. 8 and 9, the nozzle row NA0 arranged on the fourth chip CH4 is referred to as the first nozzle row NA1, and the nozzle row NA0 arranged on the first chip CH1 is referred to as the second nozzle row NA2. The second nozzle row NA2 is offset from the first nozzle row NA1 by a predetermined distance L1, which is the length of the three chips, in the transport direction D1. Details of the adjustment patterns PA1 and PA2 are described later.

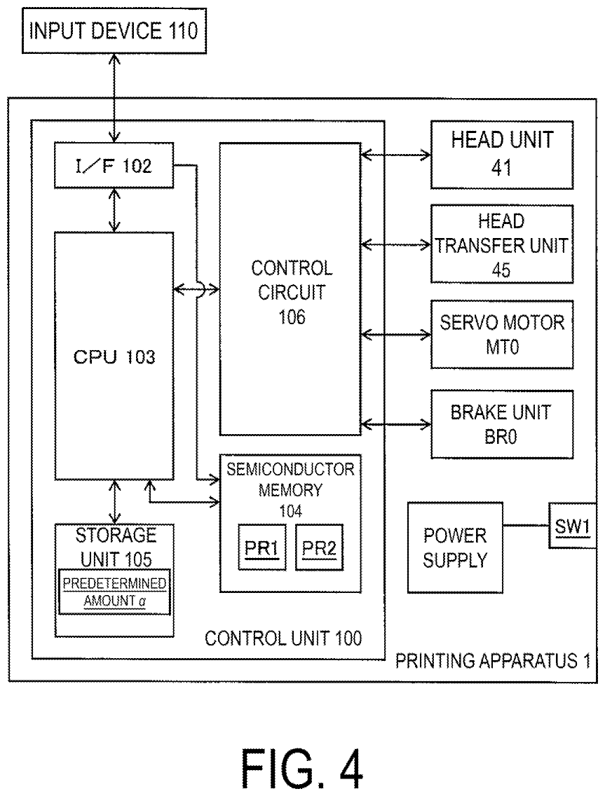

FIG. 4 schematically illustrates a configuration of an electrical circuit of the printing apparatus 1.

The printing apparatus 1 illustrated in FIG. 4 includes the control unit 100, a power supply, and a power switch SW1 in addition to the head unit 41, the head transfer unit 45, the servo motor MT0, and the brake unit BRO described above. The power supply supplies power to the units of the printing apparatus 1. The power switch SW1 is a switch for switching the power supply from off to on or from on to off. The control unit 100 includes an I/F 102, a CPU 103 which is a processor, a semiconductor memory 104 including a buffer, a storage unit 105, and a control circuit 106. Here, “I/F” is an abbreviation for “interface”, and “CPU” is an abbreviation for “central processing unit”. An input device 110 is coupled to the I/F 102. Of course, the printing apparatus 1 may include components not illustrated in FIG. 4.

The input device 110 is a host device for inputting data such as print data including an image to be printed into the printing apparatus 1. As the input device 110, a computer such as a personal computer including a tablet terminal, a mobile phone such as a smartphone, or the like can be used. The I/F 102 coupled to the input device 110 receives data such as print data from the input device 110 to store the data in the semiconductor memory 104, and transmits information such as information indicating the status of the printing apparatus 1 to the input device 110. The input device 110 is not limited to being provided separately from the printing apparatus 1, and may be provided integrally with the printing apparatus 1.

The CPU 103 is an arithmetic processing unit for controlling a printing operation of the printing apparatus 1. The semiconductor memory 104 includes a ROM and a RAM, and holds a print control program PR1 for controlling printing including the rotation of the transporting belt 23, the program PR2 for controlling adjustment pattern printing for controlling printing of the adjustment patterns PA1 and PA2 illustrated in FIGS. 8 and 9, and the like. Here, “ROM” is an abbreviation for “read only memory”, and “RAM” is an abbreviation for “random access memory”. The RAM includes a buffer for storing received print data and the like. The programs PR1 and PR2 may be written in the ROM, or may be read from the storage unit 105 and stored in the RAM. The storage unit 105 may store a predetermined amount α of the normal rotation of the drive roller 21 when the process of adjusting the tension of the transporting belt 23 is performed and the like, and may store the programs PR1 and PR2. For the storage unit 105, a nonvolatile semiconductor memory such as an EEPROM including a flash memory, a magnetic storage device such as a hard disk, or the like can be used. Here, “EEPROM” is an abbreviation for “electrically erasable programmable read only memory”. The semiconductor memory 104 and the storage unit 105 are computer-readable recording medium on which the programs PR1 and PR2 are recorded. The CPU 103 controls the units of the printing apparatus 1 in accordance with programs such as the programs PR1 and PR2 while using the RAM as a work area.

The control circuit 106 controls the operation of the head unit 41, the head transfer unit 45, the servo motor MT0, and the brake unit BRO according to the control of CPU 103. The control unit 100 causes the printing head 42 to eject ink droplets by controlling the drive of the printing head 42 of the head unit 41 according to a control signal from the control circuit 106. The control unit 100 moves the carriage 46 in the Y1 direction and the Y2 direction by controlling the drive of the power source of the head transfer unit 45 according to a control signal from the control circuit 106. Consequently, the printing head 42 reciprocates in the width direction D3 of the transporting belt 23. The control unit 100 rotates the drive roller 21 in the normal rotation direction D21 and the reverse rotation direction D22 by controlling the drive of the servo motor MT0 according to a control signal from the control circuit 106. The control unit 100 applies the brake on the driven roller 22 or releases the brake on the driven roller 22 by controlling the drive of the brake unit BRO according to a control signal from the control circuit 106.

In the printing apparatus 1, the main scanning in which the printing head 42 is caused to eject ink droplets while moving the printing head 42 in the width direction D3, and the sub scanning in which the recording medium ME0 is transported in the transport direction D1 by rotating the transporting belt 23 in the forward direction D11 by the normal rotation of the drive roller 21 are repeated substantially alternately. The sub scanning may be performed during a period during which the printing head 42 does not eject ink droplets during the main scanning period during which the main scanning is performed, or the main scanning during a period during which the printing head 42 does not eject ink droplets may be performed during the sub scanning period during which the sub scanning is performed. When the ink droplets ejected from the printing head 42 land on the recording medium ME0 during the main scanning period, dots are formed on the recording medium ME0. By repeating the main scanning and the sub scanning, a printed image represented by a dot pattern is formed on the recording medium ME0.

FIG. 5 schematically illustrates a background in which the specific example has been conceived and the tension adjustment process 200. An operation example of the transport unit 20 and the cleaning unit 50 is illustrated in FIG. 5.

In a state ST1 in which printing is performed, the servo motor MT0 rotates the drive roller 21 in the normal rotation direction D21, whereby the transporting belt 23 rotates in the forward direction D11, and the recording medium ME0 supported by the surface 23a of the transporting belt 23 is transported in the transport direction D1. Accordingly, when the transport unit 20 transports the recording medium ME0 in the transport direction D1, the transport unit 20 rotates the transporting belt 23 in the forward direction D11 in which the recording medium ME0 is transported in the transport direction D1 by rotating the drive roller 21 in the normal direction. Note that the driven roller 22 that is not braked rotates in the normal rotation direction in the same direction as the normal rotation direction D21. The cleaning unit 50 raises the cleaning section 51 and cleans the surface 23a on the lower side of the transporting belt 23 with the brush roller 58 and the blade 55.

After the printing is completed, in a maintenance state ST2 of the printing apparatus 1, the cleaning unit 50 lowers the cleaning section 51. Here, when the cleaning unit 50 raises the cleaning section 51 at the time of the next printing without back-feeding the transporting belt 23, the blade 55 comes in contact with the portion of the surface 23a of the transporting belt 23 to which the water droplets have attached by the blade 55 in the previous printing, so that part of the water droplets remaining on the surface 23a is not removed by the blade 55 and rotates together with the transporting belt 23 in the forward direction D11. Consequently, the water droplets that are not removed by the blade 55 wet the recording medium ME0, and when printing of a new design is started, the image quality of the printed image formed on the recording medium ME0 deteriorates. Thus, in accordance with the control of the control unit 100, the transport unit 20 performs the back-feeding process 220 of rotating the transporting belt 23 in the reverse direction D12 by rotating the drive roller 21 in the reverse rotation direction D22 by a predetermined amount β. The predetermined amount β in which the drive roller 21 rotates in the reverse direction can be a reverse rotation amount in which the transporting belt 23 rotates slightly in the reverse direction D12, for example, approximately 5 to 20 mm. After the back-feeding process 220, when the cleaning unit 50 raises the cleaning section 51 at the next printing, the blade 55 comes in contact with a position upstream of the portion of the surface 23a of the transporting belt 23 in which the water droplets have attached by the blade 55 in the previous printing, so that when the transporting belt 23 rotates in the forward direction D11 at the next printing, the water droplets remaining on the surface 23a of the transporting belt 23 are removed by the blade 55.

However, even when the driven roller 22 is not braked, when the drive roller 21 rotates in the reverse direction, the upper part of the transporting belt 23 that supports the recording medium ME0 is loosened. When the printing of a new design is started from this state, the surface 23a on the upper side of the transporting belt 23 fluctuates greatly in the rear-front and right-left directions, so that recording misalignment occurs in the printed image until the tension of the transporting belt 23 stabilizes at the start of printing. When the printing apparatus 1 is of the serial system, printing is performed on the recording medium ME0 in a state in which the upper part of the transporting belt 23 is loose as in the state ST2 in the first pass, which is the first main scan, and printing is performed on the recording medium ME0 in a state in which some tension is applied to the upper part of the transporting belt 23 as in the state ST1 in the second pass, which is the next main scanning. Since the tension of the upper part of the transporting belt 23 supporting the recording medium ME0 changes significantly between the state ST2 and the state ST1, the misalignment between the image formed on the recording medium ME0 in the first pass and the image formed in the second path occurs. This causes deterioration in image quality, such as thickening of thin lines and change in color. Accordingly, when the printing apparatus 1 is of the serial system, the recording misalignment at the start of printing is easily noticeable.

In the specific example, by performing the tension adjustment process 200 of rotating the drive roller 21 in the normal direction by the predetermined amount a in the state in which the driven roller 22 is braked before printing, the tension of the transporting belt 23 is adjusted to suppress the recording misalignment that occurs at the start of printing. Note that when the driven roller is always rotationally driven in the direction opposite to the rotation of the drive roller during printing, power for rotationally driving the driven roller during printing and power for rotationally driving the drive roller so as to overcome the rotational drive of the driven roller are required. Since the specific example does not require these pieces of power, the recording misalignment that occurs at the start of printing can be suppressed with low power consumption.

In order to perform the tension adjustment process 200, the transport unit 20 includes the brake unit BRO that can apply a brake on the driven roller 22. For the brake unit BRO, a brake using an electromagnetic force such as an electromagnetic brake, a mechanical brake such as a disk brake or a drum brake, or the like can be used. In the above-described states ST1 and ST2, the brake unit BRO releases the brake on the driven roller 22. “OFF” illustrated in FIG. 5 means that the brake on the driven roller 22 is released.

After the back-feeding process 220 is performed, in a state ST3 of adjusting the tension of the transporting belt 23, the tension adjustment process 200 is performed. The brake unit BRO brakes the driven roller 22, and the servo motor MT0 rotates the drive roller 21 in the normal rotation direction D21 by the predetermined amount α. “ON” illustrated in FIG. 5 means that the driven roller 22 is braked. The predetermined amount α is a control amount of the drive roller 21, and is output from the control unit 100 to the servo motor MT0. The predetermined amount a in which the drive roller 21 rotates in the normal direction can be a normal rotation amount in which the transporting belt 23 rotates slightly in the forward direction D11, for example, approximately 1 to 10 mm. When the drive roller 21 rotates in the normal direction in the state in which the driven roller 22 is braked, the upper part of the transporting belt 23 that supports the recording medium ME0 is pulled in the forward direction D11, and looseness of the upper part of the transporting belt 23 is eliminated. Accordingly, the method for adjusting the tension of the transporting belt 23 in the printing apparatus 1 includes a step of adjusting the tension of the transporting belt 23 by rotating the drive roller 21 in the normal direction in the state in which the driven roller 22 is braked before printing. Note that in the tension adjustment state ST3, the cleaning unit 50 raises the cleaning section 51.

The control unit 100 controls the torque of the servo motor MT0 in the normal rotation direction D21 when the tension adjustment process 200 is performed so as to be the torque of the servo motor MT0 in the normal rotation direction D21 when printing is performed. In other words, the control unit 100 controls the acceleration of the normal rotation of the drive roller 21 when the tension adjustment process 200 is performed so as to be equal to the acceleration of the normal rotation of the drive roller 21 when printing is performed. As a result, the upper part of the transporting belt 23 that supports the recording medium ME0 has appropriate tension.

After the tension adjustment process 200 is performed, the brake unit BRO releases the brake on the driven roller 22, and the cleaning unit 50 raises the cleaning section 51. In the embodiment, the cleaning section 51 is raised by the cleaning unit 50 after the tension adjustment process 200 is performed, but the cleaning section 51 may be raised after the back-feeding. In a state ST4 in which the next printing is performed, the tension of the upper part of the transporting belt 23 is maintained, and the servo motor MT0 rotates the drive roller 21 in the normal direction, whereby the transporting belt 23 rotates in the forward direction D11, and the recording medium ME0 supported by the surface 23a of the transporting belt 23 is transported in the transport direction D1. By starting printing of a new design from the tension adjustment state ST3, the fluctuation of the surface 23a on the upper side of the transporting belt 23 is small, and recording misalignment that occurs at the start of printing is suppressed. Note that when raising the cleaning section 51 after performing the tension adjustment process 200, it is preferable to set α≤β in order to securely remove the water droplets remaining on the surface 23a of the transporting belt 23.

### 3. SPECIFIC EXAMPLE OF PRINTING PROCESS PERFORMED IN PRINTING APPARATUS

Next, an example of the printing process performed in the printing apparatus 1 will be described with reference to FIG. 6 and the like. The printing process illustrated in FIG. 6 is mainly performed by the control unit 100. When the power switch SW1 illustrated in FIG. 4 is turned on, the printing process is started. In FIG. 6, steps S104 to 106 correspond to the tension adjustment process 200. Steps S102 to S108 correspond to the print preparation period 210 including a period in which the printing head 42 is located in the flushing area AR2 illustrated in FIG. 2. Step S114 corresponds to the back-feeding process 220. Hereinafter, the description of “step” will be omitted, and the sign of the step will be in parentheses.

First, the control unit 100 causes the printing unit 40 illustrated in FIGS. 1 and 2 to execute pre-printing flushing (S102). The pre-printing flushing means to move the printing head 42 to the flushing area AR2 and cause the printing head 42 to eject ink droplets toward the ink receiver 47 before printing in order to prevent ink droplet ejection failure due to thickening of ink or the like. The printing head 42 is located in the flushing area AR2 during at least part of the print preparation period 210 of S102 to S108.

After the start of the pre-printing flushing, the control unit 100 issues a command to the brake unit BRO to brake the driven roller 22, so that the driven roller 22 is in the state of being braked by the brake unit BRO (S104). In this state, the control unit 100 issues a command to the servo motor MT0 to rotate the drive roller 21 in the normal direction by the predetermined amount α, thereby rotating the drive roller 21 in the normal direction by the predetermined amount α (S106). The control unit 100 can use the predetermined amount a stored in the storage unit 105 illustrated in FIG. 4 for the processing of S106. In addition, the control unit 100 controls the acceleration of the normal rotation of the drive roller 21 when the tension adjustment process 200 is performed so as to be equal to the acceleration of the normal rotation of the drive roller 21 when the printing is performed.

When the drive roller 21 rotates in the normal direction in the state in which the driven roller 22 is braked, the upper part of the transporting belt 23 that supports the recording medium ME0 is pulled in the forward direction D11, and looseness of the upper part of the transporting belt 23 is eliminated. This state corresponds to the tension adjustment state ST3 illustrated in FIG. 5. In this manner, the control unit 100 causes the transport unit 20 to perform the tension adjustment process 200 of adjusting the tension of the transporting belt 23 by rotating the drive roller 21 in the normal direction in the state in which the driven roller 22 is braked by the brake unit BRO before printing. In the case in which the tension adjustment process 200 is performed when the printing apparatus 1 is powered on, the control unit 100 causes the transport unit 20 to perform the tension adjustment process 200 when the power is turned on.

After the tension adjustment process 200, the control unit 100 issues a command to the brake unit BRO to release the brake on the driven roller 22, so that the brake on the driven roller 22 by the brake unit BRO is released (S108). In addition, the control unit 100 causes the cleaning unit 50 to raise the cleaning section 51. Note that the raising of the cleaning section 51 may be manually operated.

As described above, the control unit 100 causes the transport unit 20 to perform the tension adjustment process 200 during the print preparation period 210 including the period in which the printing head 42 is located in the flushing area AR2. Note that the pre-printing flushing may be completed before the print execution processing S110.

Subsequently, the control unit 100 causes the printing head 42 to repeat the main scanning for ejecting ink droplets and causes the transport unit 20 to repeat the sub scanning for transporting the recording medium ME0 in the transport direction D1, to execute printing (S110). This state corresponds to the printing state ST1 illustrated in FIG. 5. In this way, when the control unit 100 causes the transport unit 20 to transport the recording medium ME0 in the transport direction D1, the transport unit 20 rotates the transporting belt 23 in the forward direction D11 in which the recording medium ME0 is transported in the transport direction D1 by rotating the drive roller 21 in the normal direction.

After printing is completed, the control unit 100 causes the cleaning unit 50 to lower the cleaning section 51 (S112). Note that the lowering of the cleaning section 51 may be manually operated.

After the cleaning section 51 is lowered, the control unit 100 issues a command to the servo motor MT0 to rotate the drive roller 21 in the reverse direction by the predetermined amount β, thereby rotating the drive roller 21 in the reverse direction by the predetermined amount β, and rotating the transporting belt 23 in the reverse direction D12 (S114). This state corresponds to the maintenance state ST2 illustrated in FIG. 5. Since the drive roller 21 is rotated in the reverse direction, the upper part of the transporting belt 23 that supports the recording medium ME0 is loosened. When the control unit 100 executes the next printing (S116), the control unit 100 returns the processing to S102. Hereinafter, the process from the back-feeding process 220 of S114 to the next printing will be described.

After the back-feeding process 220, the control unit 100 causes the printing unit 40 illustrated in FIGS. 1 and 2 to execute the pre-print flushing (S102). After the start of the pre-printing flushing, the control unit 100 issues a command to the brake unit BRO to brake the driven roller 22, so that the driven roller 22 is in the state of being braked by the brake unit BRO (S104). In this state, the control unit 100 issues a command to the servo motor MT0 to rotate the drive roller 21 in the normal direction by the predetermined amount α, thereby rotating the drive roller 21 in the normal direction by the predetermined amount α (S106). Consequently, the upper part of the transporting belt 23 that supports the recording medium ME0 is pulled in the forward direction D11, and looseness of the upper part of the transporting belt 23 is eliminated. This state corresponds to the tension adjustment state ST3 illustrated in FIG. 5. When the tension adjustment process 200 is performed after the back-feeding process 220, the control unit 100 causes the transport unit 20 to perform the tension adjustment process 200 after the back-feeding process 220 and before printing.

After the tension adjustment process 200, the control unit 100 issues a command to the brake unit BRO to release the brake on the driven roller 22, so that the brake on the driven roller 22 by the brake unit BRO is released (S108). In addition, the control unit 100 causes the cleaning unit 50 to raise the cleaning section 51. Note that the raising of the cleaning section 51 may be manually operated.

Subsequently, the control unit 100 causes the printing head 42 to repeat the main scanning for ejecting ink droplets and causes the transport unit 20 to repeat the sub scanning for transporting the recording medium ME0 in the transport direction D1, to execute printing (S110). This state corresponds to the printing state ST4 illustrated in FIG. 5. After printing is completed, the control unit 100 causes the cleaning unit 50 to lower the cleaning section 51 (S112). Note that the lowering of the cleaning section 51 may be manually operated.

After the cleaning section 51 is lowered, the control unit 100 causes the transport unit 20 to perform the back-feeding process 220 (S114). The control unit 100 determines whether to execute the next printing (S116), returns the processing to S102 when the next printing is executed, and terminates the printing process illustrated in FIG. 6 when the next printing is not executed. When the next printing is not executed, the back-feeding process 220 of S114 before the determination may be omitted.

As described above, even when the upper part of the transporting belt 23 that supports the recording medium ME0 is loosened by the back-feeding process 220, the drive roller 21 rotates in the normal direction in the state in which the driven roller 22 is braked before printing, so that the tension of the transporting belt 23 is adjusted. Accordingly, it is possible to suppress the recording misalignment due to looseness of the support portion of the transporting belt 23 for supporting the recording medium ME0 due to the back-feeding.

In addition, even when the upper part of the transporting belt 23 that supports the recording medium ME0 is loose when the printing apparatus 1 is powered on, the drive roller 21 rotates in the normal direction in the state in which the driven roller 22 is braked before printing, so that the tension of the transporting belt 23 is adjusted. Accordingly, even when the support portion of the transporting belt 23 for supporting the recording medium ME0 is loose when power is turned on, the recording misalignment can be suppressed.

### 4. SPECIFIC EXAMPLE OF DETERMINING NORMAL ROTATION AMOUNT OF DRIVE ROLLER IN TENSION ADJUSTMENT PROCESS

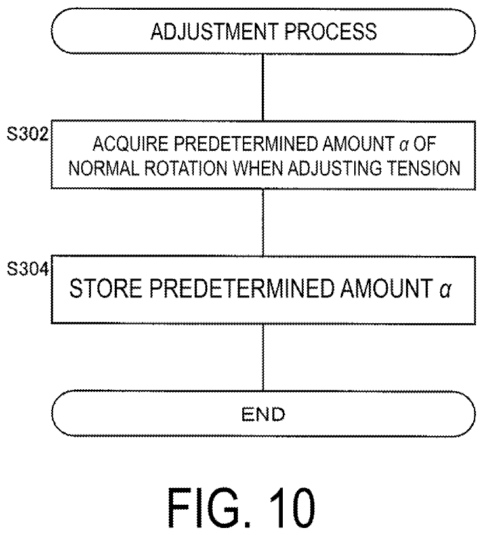

The predetermined amount a of the normal rotation of the drive roller 21 in the tension adjustment process 200 can be set by performing an adjustment pattern printing process illustrated in FIG. 7 and performing an adjustment process illustrated in FIG. 10.

FIG. 7 schematically illustrates the adjustment pattern printing process performed in the printing apparatus 1. The adjustment pattern printing process is started when the input device 110 or the like receives an instruction to print the adjustment patterns PA1 and PA2 illustrated in FIGS. 8 and 9, and is mainly executed by the control unit 100. FIG. 8 schematically illustrates a state in which the printing apparatus 1 prints the adjustment patterns PA1 and PA2. FIG. 9 schematically illustrates a plurality of adjustment patterns printed by changing the normal rotation amount αi. For clarity, only one of cyan, magenta, yellow, and black nozzle rows NA0 is illustrated in FIGS. 8 and 9. FIG. 10 schematically illustrates the adjustment process performed in the printing apparatus 1. The adjustment process is started when the adjustment pattern printing process illustrated in FIG. 7 is completed, and is mainly executed by the control unit 100.

In FIGS. 7, S202 and S218 correspond to the back-feeding function HA that performs the first process. S204 to S210 correspond to the tension adjustment function FU2 that performs the second process. S212 corresponds to the first print control function FU3 that performs the third process. S214 corresponds to the transport control function FU4 that performs the fourth process. S216 corresponds to the second print control function FU5 that performs the fifth process.

When the adjustment pattern printing process illustrated in FIG. 7 starts, the control unit 100 issues a command to the servo motor MT0 to rotate the drive roller 21 in the reverse direction by the predetermined amount β, thereby rotating the drive roller 21 in the reverse direction by the predetermined amount β, and rotating the transporting belt 23 in the reverse direction D12 (S202). Consequently, the upper part of the transporting belt 23 that supports the recording medium ME0 is loosened as in the maintenance state ST2 illustrated in FIG. 5.

After the back-feeding of the transporting belt 23, the control unit 100 sets the normal rotation amount αi at the time of tension adjustment (S204). The normal rotation amount αi is a set amount of the normal rotation of the drive roller 21 when the tension adjustment process is performed, and can be a rotation amount of the drive roller 21 corresponding to the displacement of the transporting belt 23 in the forward direction D11, for example, 1 mm, 2 mm, 3 mm, and the like. Hereinafter, the normal rotation amount αi will be referred to as the set amount αi. After the set amount αi is set, the control unit 100 issues a command to the brake unit BRO to brake the driven roller 22, so that the driven roller 22 is in the state of being braked by the brake unit BRO (S206). In this state, the control unit 100 issues a command to the servo motor MT0 to rotate the drive roller 21 in the normal direction by the set amount αi, thereby rotating the drive roller 21 in the normal direction by the set amount αi (S208). Consequently, the looseness of the upper part of the transporting belt 23 is reduced in accordance with the set amount αi. S206 to S208 correspond to the tension adjustment process 200 described above.

After the drive roller 21 is rotated in the normal direction, the control unit 100 issues a command to the brake unit BRO to release the brake on the driven roller 22, so that the brake on the driven roller 22 by the brake unit BRO is released (S210).

Subsequently, as illustrated in the upper part of FIG. 8, the control unit 100 causes the printing head 42 to print the first adjustment pattern PA1 on the recording medium ME0 by ejecting the ink droplets 48 from the first nozzle row NA1 of the fourth chip CH4 (S212). On the upper part of FIG. 8, a state ST11 is illustrated in which the first adjustment pattern PA1 is printed. Since the adjustment patterns PA1 and PA2 are printed in order to determine the predetermined amount α of the normal rotation of the drive roller 21, unidirectional printing in which the adjustment patterns PA1 and PA2 are formed on the recording medium ME0 only when the printing head 42 is moving in the Y1 direction is preferable. Of course, the unidirectional printing may be printing in which the adjustment patterns PA1 and PA2 are formed on the recording medium ME0 only when the printing head 42 is moving in the Y2 direction. The first adjustment pattern PA1 and the second adjustment pattern PA2 preferably have the same shape but are not limited thereto. The adjustment patterns PA1 and PA2 illustrated in FIG. 8 have a cross shape so that the misalignments in the transport direction D1 and the width direction D3 can be easily recognized. Of course, the shape of the adjustment patterns PA1 and PA2 is not limited to the cross shape, but may be a polygonal shape such as a quadrangular shape. The color of the adjustment patterns PA1 and PA2 may be a single color such as black, which is easy to see, or a combination of multiple colors. When the adjustment patterns PA1 and PA2 are printed for each of cyan, magenta, yellow, and black, the ink droplet ejection failure of each color can be confirmed.

After printing the first adjustment pattern PA1, the control unit 100 issues a command to the servo motor MT0 to rotate the drive roller 21 in the normal direction so as to transport the recording medium ME0 in the transport direction D1 by the predetermined distance L1 (S214). In other words, the control unit 100 causes the transport unit 20 to rotate the transporting belt 23 in the forward direction D11 by rotating the drive roller 21 in the normal direction to transport the recording medium ME0 in the transport direction D1 by the predetermined distance L1. The predetermined distance L1 is an offset distance between the first nozzle row NA1 of the fourth chip CH4 and the second nozzle row NA2 of the first chip CH1 in the transport direction D1.

Subsequently, as illustrated in the lower part of FIG. 8, the control unit 100 causes the printing head 42 to print the second adjustment pattern PA2 on the recording medium ME0 by ejecting the ink droplets 48 from the second nozzle row NA2 of the first chip CH1 (S216). On the lower part of FIG. 8, a state ST12 is illustrated in which the second adjustment pattern PA2 is printed. When the looseness of the upper part of the transporting belt 23 that supports the recording medium ME0 is appropriately eliminated, the printing position of the first adjustment pattern PA1 and the printing position of the second adjustment pattern PA2 are substantially the same. When the looseness of the upper part of the transporting belt 23 has not been eliminated, the printing position of the second adjustment pattern PA2 is misaligned to the printing position of the first adjustment pattern PA1.

After printing the second adjustment pattern PA2, the control unit 100 issues a command to the servo motor MT0 to rotate the drive roller 21 in the reverse direction so as to transport the recording medium ME0 in the back-feeding direction D2 by the predetermined distance L1 (S218). In other words, the control unit 100 causes the transport unit 20 to rotate the transporting belt 23 in the reverse direction D12 by rotating the drive roller 21 in the reverse direction to transport the recording medium ME0 in the back-feeding direction D2 by the predetermined distance L1. Consequently, the upper part of the transporting belt 23 that supports the recording medium ME0 is loosened as in the maintenance state ST2 illustrated in FIG. 5.

Subsequently, the control unit 100 branches the processing according to whether the next adjustment patterns PA1 and PA2 are to be printed by changing the set amount αi of the normal rotation of the drive roller 21 (S220). When the next adjustment patterns PA1 and PA2 are to be printed, the control unit 100 repeats the pieces of processing from S204 to S220. The control unit 100 may control to print new adjustment patterns PA1 and PA2 at positions that do not overlap with the already printed adjustment patterns PA1 and PA2 in S212 and S216. For example, it is assumed that the set amount αi is set in the order of 1 mm, 2 mm, and 3 mm. FIG. 9 illustrates a state ST21 in which the adjustment patterns PA1 and PA2 are printed when the set amount α1 is 1 mm, a state ST22 in which the adjustment patterns PA1 and PA2 are printed when the set amount a2 is 2 mm, and a state ST23 in which the adjustment patterns PA1 and PA2 are printed when the set amount a3 is 3 mm.

When the next adjustment patterns PA1 and PA2 are not to be printed, the control unit 100 terminates the adjustment pattern printing process illustrated in FIG. 7.

The predetermined amount a of the normal rotation of the drive roller 21 can be determined according to the adjustment process illustrated in FIG. 10.

When the adjustment process starts, the control unit 100 acquires the predetermined amount α of the normal rotation when the tension adjustment process 200 is performed (S302). For example, the control unit 100 can acquire the predetermined amount a by receiving an input of the predetermined amount α from the input device 110. A user who sees the adjustment patterns PA1 and PA2 illustrated in FIG. 9 may operate and input the set amount α3 having the smallest misalignment between the adjustment patterns PA1 and PA2 from the set amounts α1, α2, and α3 to the input device 110 as the predetermined amount a. Alternatively, an imaging device coupled to the printing apparatus 1 or the input device 110 may image the adjustment patterns PA1 and PA2 with all the set amounts αi, and the printing device 1 or the input device 110 may analyze the captured image acquired from the imaging device. Thereby, the set amount α3 corresponding to the adjustment patterns PA1 and PA2 in which the misalignment therebetween is the minimum may be acquired.

After the predetermined amount α is acquired, the control unit 100 causes the storage unit 105 illustrated in FIG. 4 to store the acquired predetermined amount a (S304), and terminates the adjustment process. When the printing process illustrated in FIG. 6 is performed, the predetermined amount α stored in the storage unit 105 is used in the processing of S106.

As described above, when there is the recording misalignment at the start of printing, the misalignment occurs between the first adjustment pattern PA1 and the second adjustment pattern PA2. In the specific example, the extent of recording misalignment in accordance with the normal rotation amount of the drive roller 21 at the time of tension adjustment can be confirmed based on the printed adjustment patterns PA1 and PA2 illustrated in FIG. 9. Additionally, in the specific example, when the tension adjustment process 200 is performed, the predetermined amount a of the normal rotation of the drive roller 21 can be determined so that the recording misalignment between the adjustment patterns PA1 and PA2 is reduced. As a result, the recording misalignment occurring at the start of printing can be suppressed.

### 5. MODIFIED EXAMPLES

Within the scope of the present disclosure, various modified examples are conceivable.

For example, the printing apparatus is not limited to the serial ink jet printer, and may be a line ink jet printer having a plurality of nozzles arranged in the width direction of the transporting belt over the entire width of the recording medium.

The combination of coloring materials that form an image on the recording medium is not limited to the combination of cyan, magenta, yellow, and black. Examples of coloring materials may include light cyan having a lighter color than cyan, light magenta having a lighter color than magenta, dark yellow having a darker color than yellow, light black having a lighter color than black, orange, green, and an uncolored coloring material for improving image quality. In addition, the present technique can be applied even when some coloring materials of cyan, magenta, yellow, and black are not used.

Note that even in a case in which the tension adjustment process 200 is performed after the back-feeding process 220 without performing the tension adjustment process 200 when the printing apparatus 1 is powered on, even in a case in which the tension adjustment process 200 is performed when the printing apparatus 1 is powered on without performing the tension adjustment process 200 after the back-feeding process 220, and the like, the basic effect of suppressing the recording misalignment occurring at the start of printing can be obtained.

### 6. SUMMARY

As described above, according to the various aspects of the present disclosure, it is possible to provide a technique and the like for suppressing the recording misalignment that occurs at the start of printing. Of course, even a technique including only the components recited in the independent claims produces the above-described basic advantages.

Furthermore, the aspects of the disclosure can implement configurations resulting from mutual replacement of components disclosed in the above-described examples or a change in the combination of the components, configurations resulting from mutual replacement of components disclosed in the known art and the above-described examples or a change in the combination of the components, and the like. The present disclosure includes these configurations and the like.

What is claimed is:

1. A printing apparatus comprising:
a transport unit including a drive roller configured to rotate in a normal direction and in a reverse direction, a driven roller, and an endless transporting belt stretched between the drive roller and the driven roller to support a recording medium, and transporting the recording medium supported by the transporting belt that is rotated by drive of the drive roller, in a transport direction by rotating the drive roller in the normal direction;
a printing head configured to perform printing on the recording medium supported by the transporting belt; and
a control unit configured to cause the transport unit to rotate the transporting belt in a forward direction in which the recording medium is transported in the transport direction by rotating the drive roller in the normal direction when causing the transport unit to transport the recording medium in the transport direction, wherein
the transport unit includes a brake unit configured to apply a brake on the driven roller, and
the control unit causes the transport unit to perform a tension adjustment process of adjusting tension of the transporting belt by rotating the drive roller in the normal direction in a state in which the driven roller is braked by the brake unit before the printing.

2. The printing apparatus according to claim 1, wherein
the control unit
causes the transport unit to perform a back-feeding process of rotating the transporting belt in a reverse direction by rotating the drive roller in the reverse direction,
causes the transport unit to perform the tension adjustment process after the back-feeding process and before the printing, and
causes the transport unit to release the brake applied on the driven roller by the brake unit before the printing.

3. The printing apparatus according to claim 1 further comprising:
a head transfer unit configured to move the printing head to a print execution area facing the transporting belt and a flushing area not facing the transporting belt, wherein
the control unit causes the transport unit to perform the tension adjustment process during a print preparation period including a period during which the printing head is located in the flushing area.

4. The printing apparatus according to claim 1, wherein the control unit performs control so that acceleration of the normal rotation of the drive roller when the tension adjustment process is performed is equal to acceleration of the normal rotation of the drive roller when the printing is performed.

5. The printing apparatus according to claim 1, wherein the control unit causes the transport unit to perform the tension adjustment process when the printing apparatus is powered on.

6. A method for adjusting tension of a transporting belt in a printing apparatus, wherein
the printing apparatus includes
a transport unit including a drive roller configured to rotate in a normal direction and in a reverse direction, a driven roller, and an endless transporting belt stretched between the drive roller and the driven roller to support a recording medium, and transporting the recording medium supported by the transporting belt that is rotated by drive of the drive roller, in a transport direction by rotating the drive roller in the normal direction, and
a printing head configured to perform printing on the recording medium supported by the transporting belt, and
the transport unit rotates the transporting belt in a forward direction in which the recording medium is transported in the transport direction by rotating the drive roller in the normal direction when transporting the recording medium in the transport direction, the method comprising:
adjusting the tension of the transporting belt by rotating the drive roller in the normal direction in a state in which the driven roller is braked before the printing.

7. A non-transitory computer-readable storage medium storing a program for controlling adjustment pattern printing for a printing apparatus, wherein
the printing apparatus includes
a transport unit including a drive roller configured to rotate in a normal direction and in a reverse direction, a driven roller, and an endless transporting belt stretched between the drive roller and the driven roller to support a recording medium, and transporting the recording medium supported by the transporting belt that is rotated by drive of the drive roller, in a transport direction by rotating the drive roller in the normal direction, and
a printing head including a plurality of nozzles arranged in an arrangement direction intersecting a width direction of the transporting belt and configured to perform printing on the recording medium supported by the transporting belt,
the transport unit rotates the transporting belt in a forward direction in which the recording medium is transported in the transport direction by rotating the drive roller in the normal direction when transporting the recording medium in the transport direction,
the plurality of nozzles include a first nozzle row and a second nozzle row that is offset from the first nozzle row in the transport direction by a predetermined distance, and
the transport unit includes a brake unit configured to apply a brake on the driven roller, the program causing a computer to implement
a back-feeding function configured to perform a first process of rotating the transporting belt in a reverse direction by a predetermined amount by causing the transport unit to rotate the drive roller in the reverse direction,
a tension adjustment function configured to perform a second process of causing the transport unit to rotate the drive roller in the normal direction by a set amount in a state in which the driven roller is braked by the brake unit after the first process,
a first print control function configured to perform a third process of printing a first adjustment pattern on the recording medium by causing the printing head to eject an ink droplet from the first nozzle row after the second process,
a transport control function configured to perform a fourth process of transporting the recording medium in the transport direction by the predetermined distance by causing the transport unit to rotate the drive roller in the normal direction after the third process, and
a second printing control function configured to perform a fifth process of printing a second adjustment pattern on the recording medium by causing the printing head to eject ink droplets from the second nozzle row after the fourth process.
